(19) United States
(12) Patent Application Publication
(10) Pub. No.: US 2003/0110038 A1
(43) Pub. Date: Jun. 12, 2003

(54) Multi-modal gender classification using support vector machines (SVMs)

(76) Inventors: Rajeev Sharma, State College, PA (US); Mohammed Yeasin, State College, PA (US); Leena A. Walavalkar, State College, PA (US)

Correspondence Address: Mark D. Simpson, Esquire, Synnestvedt & Lechner LLP, 2600 Aramark Tower, 1101 Market Street, Philadelphia, PA, 19107-2950, US

(21) Appl. No.: 10/271,911

(22) Filed: Oct. 16, 2002

Related U.S. Application Data
(60) Provisional application No. 60/330,492, filed on Oct. 16, 2001.

(51) Int. Cl. G10L 21/00

(52) U.S. Cl. 704/270

(57) ABSTRACT

A multi-modal system for determining the gender of a person using support vector machines (SVMs). Gender classification is first performed on visual (thumbnail frontal face) and audio (feature extracted from speech) data using support vector machines (SVMs). The decisions obtained from individual SVM-based gender classifiers are used as input to train a final classifier to decide the gender of an individual.

### CROSS-REFERENCE TO RELATED APPLICATIONS

This application is based on and claims priority to U.S. Provisional Application No. 60/330,492, filed Oct. 16, 2001, which is fully incorporated herein by reference.

### STATEMENT REGARDING FEDERALLY-SPONSORED RESEARCH

This development was supported in part by the NSF Career Grant IIS-97-33644 and NSF Grant IIS-0081935. The government may have certain rights in this invention.

### FIELD OF THE INVENTION

This invention relates to human-feature recognition systems and, more particularly, to an automated method and system for identifying gender.

### BACKGROUND OF THE INVENTION

From information exchange to making many important decisions, humans typically depend upon visual and audio information for communication. Humans can easily tell the difference between men and women. Psychologists have discovered a number of key facts about the perception of gender in faces. A large number of studies have shown that gender judgments are made very fast. One of the most important findings on perception of gender is that it proceeds independently of the perception of identity. Human beings also have the extraordinary ability to learn and remember the patterns they hear and see and associate a category to each pattern. Human beings are capable of easily recognizing spoken words and identifying known faces by processing raw audio and visual information, respectively. From either of these cues, humans are able to judge several characteristics such as age, gender, and emotional state of the person. Human beings can quite accurately distinguish gender even in the presence and/or absence of pathological features, for example, hairstyle, makeup and facial hair.

As computers have evolved, understandably efforts have been directed to developing computer systems that can interact with humans using visual or audio information as cues, providing ease-of-use in human computer interaction (HCI) systems. Computer systems that visually monitor environments and identify people are already playing an increasingly important role in our lives. For example, face recognition and “iris scan” technology have been used for allowing or denying access to buildings and/or sensitive areas within buildings, thereby increasing the level of security for the buildings and/or areas.

Studies have shown that both facial features and speech features contain important information that make it possible to classify the gender of a subject. Gender classification has received attention from both computer vision and speech/speaker recognition researchers. However, research has progressed in parallel, i.e., classification of gender has been performed using either visual (thumbnail frontal face) or audio cues. Prior art methods of automating gender classification using only visual cues has limitations; for example, prior art visual gender classification methods are highly dependent on proper head orientation and require fully frontal facial images. Prior art methods of gender classification using audio cues are also limited; for example, speech samples are usually obtained from noisy environments, making gender determination much more difficult. Prior research has been focused on reducing these and other limitations within a single mode, i.e., either visual or audio.

Automated gender classification using visual information has traditionally been accomplished using template matching, and traditional classifiers (i.e., linear, quadratic, Fisher linear discriminant, nearest neighbor, and radial basis functions). Recently, SVMs have been used for the task of gender classification using face images and typically outperform other traditional classifiers.

Early attempts at applying computer vision techniques to gender recognition were reported in 1991. Cottrell and Metcalfe used neural networks for face, emotion and gender recognition. Golomb et al., trained a fully connected two-layer neural network, “Sexnet”, to identify gender from 30×30 pixel human face images. Tamura et al., applied a multi-layer neural network to classify gender from face images of multiple resolutions ranging from 32×32 pixels to 16×16 pixels to 8×8 pixels. Brunelli and Poggio used a different approach in which a set of geometrical features (e.g., pupil to eyebrow separation, eyebrow thickness, and nose width) was computed from the frontal view of a face image without hair information. Gutta et al., proposed a hybrid method that consists of an ensemble of neural networks (RBF Networks) and inductive decision trees (DTs) with Quinlan's C4.5 algorithm.

Gutta et al. also used a mixture of different classifiers consisting of ensembles of radial basis functions. Inductive decision trees and SVMs were used to decide which of the classifiers should be used to determine the classification output and restrict the support of input space. More recent work reported by Gutta on gender classification used low resolution 21×12 pixel thumbnail faces processed from 1755 images from the FERET database. SVMs were used for classification of gender and were compared to traditional pattern classifiers like linear, quadratic, Fisher Linear Discriminant, Nearest Neighbor and the Radial Basis Function. Gutta found that SVMs outperformed the other methods.

Automated gender classification has also been approached using speech data. The techniques used for speech-based gender recognition are drawn from research on a similar problem of speaker identification. There has been relatively less attention devoted to the problem of speech-based gender classification itself. Moreover, previous techniques have been focused towards finding the best speech feature for classification, so that recognition can be independent of the particular language being used in the speech sample to achieve language independence. Ordinary classifiers (i.e., linear and Gaussian) are used for prior art speech classification methods.

The earliest work related to gender recognition using speech samples was by Childers et al. The Childers experiments were performed using “clean” speech samples obtained from a controlled, low-noise environment obtained from a database of 52 speakers. The features used were linear prediction coefficients (LPC), cepstral, autocorrelation, reflection, and mel-cepstral coefficients. Five different distance measures were examined. A follow up study concluded that gender information is time invariant, phoneme invariant, and speaker independent for a given gender. Various reported studies also suggested that rendering speech to a parametric representation such as LPC, Cepstrum, or reflection coefficients is more appropriate approach for gender recognition than using fundamental frequency and formant feature vectors.

Fussell extracted cepstral coefficients from very short (16 ms) segments of speech to perform gender recognition using a simple Gaussian classifier. Parris and Carey proposed a gender identification system that used two sets of Hidden Markov Models (HMMs) that were matched to speech using the Viterbi algorithm, and the most likely sequence of models with corresponding likelihood scores were produced. The system was tested on speakers of 12 different languages including British-English and US-English. Slomka and Sridharan tried to further optimize gender recognition to achieve language independence, i.e., so that gender recognition could be achieved regardless of the language of the speech used in the sample. The results show that the combination of melcepstral coefficients and average estimate of pitch gave the best overall accuracy.

It is evident from the studies, however, that no particular prior art feature or technique alone is capable of achieving very accurate recognition and generalization over a large set of data. The individual attempts at performing gender recognition using either audio or visual cues point out the shortcomings of each approach. For example, as noted above, the prior art methods for visual gender classifier are very sensitive to head orientation and require fully frontal facial images. While these methods may function quite well with standard “mugshots” (e.g., passport photos), the inability to recognize gender increases as photographs taken from different angles are used. This presents a significant limitation to visual gender recognition, a limitation which detrimentally affects its utility in unconstrained (non-controlled) imaging environments. Prior art methods of visual gender classification also demand a high level of computational power and time.

Prior art speech based gender classification methods do not require the computational power and time required of visual systems. However, unlike the vision approach, more modern and sophisticated classifiers have not been explored in case of speech, and environmental noise in uncontrolled speech environments limits the accuracy of a speech-only based gender recognition system.

### SUMMARY OF THE INVENTION

The present invention combines multiple modes of recognition systems (e.g., visual and audio), to achieve a gender recognition system that takes advantage of the beneficial aspects of the types of systems used, to achieve a better performing, robust gender recognition system. In a preferred embodiment, preliminary gender classification is performed on both visual (e.g., thumbnail frontal face) and audio (features extracted from speech) data using support vector machines (SVMs). The preliminary classifications obtained from the separate SVM-based gender classifiers are combined and used as input to train a final classifier to decide the gender of the person based on both types of data. Use of multiple (audio and visual) cues and decisions made during preliminary classification stages improves on the final decision, and this novel approach is referred to as multi-modal learning (MML), and when used for gender classification it is referred to as multi-modal gender classification. Multi-modal gender classification using the present invention yields a significant reduction in misclassification as compared to the single-mode gender classification methods of the prior art.

### BRIEF DESCRIPTION OF THE DRAWINGS

FIG. 1 is a block diagram illustrating the basic operation of the present invention;

FIG. 2 is a flowchart illustrating the steps performed in training the classifiers of the present invention; and

FIGS. 3-5 illustrate number-line representations of hypothetical data relating to a four-member data set.

### DETAILED DESCRIPTION OF THE INVENTION

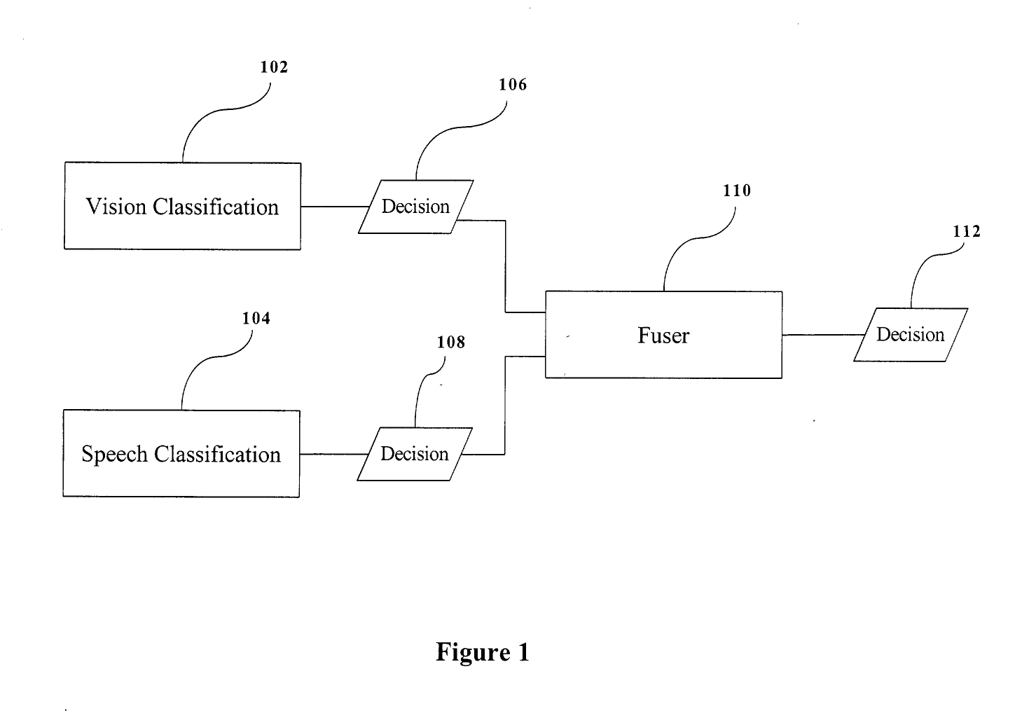

FIG. 1 is a block diagram illustrating the basic operation of the present invention. Referring to FIG. 1, raw vision data is input to vision classifier 102 and raw speech data is input to speech classifier 104. Vision classifier 102 classifies the raw data according to gender (male or female) and outputs a decision to decision block 106. Similarly, the raw speech data is analyzed by speech classifier 104 and, based upon this analysis, a decision (male or female) is output at decision block 108. The decisions made by the vision classifier 102 and speech classifier 104 are then input to fuser (combiner) 110, which combines the decisions made by vision classifier 102 and speech classifier 104 and, based upon analyzing these decisions and the data on which the decisions were based, renders a final decision of gender at block 112. Using this system, the benefits of each system can be combined to result in a more accurate and robust system.

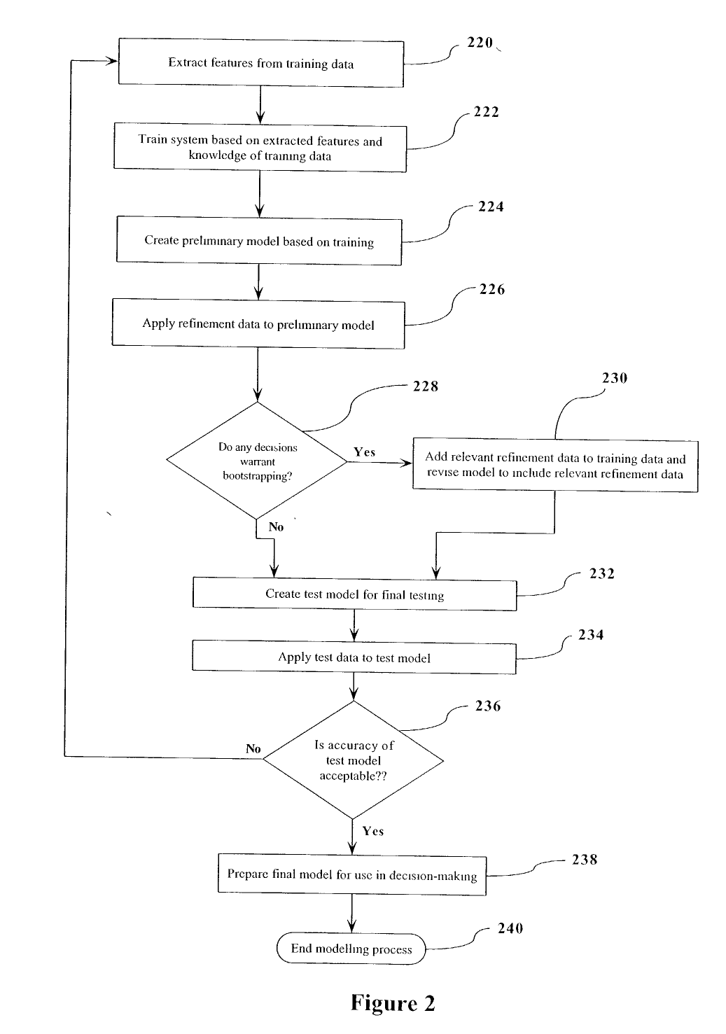

FIG. 2 is a flowchart illustrating the steps performed in training the classifiers of the present invention. In general, the steps of FIG. 2 are performed by both the single mode (e.g., vision or speech) classifier as well as the multi-mode (e.g., vision and speech) fuser 110. Referring to FIG. 2, at step 220, training data set is input to the classifier and analyzed to identify characteristics related to the data. The training data set comprises speech and/or visual data for which the gender information is known. For example, the training data set can comprise video or photographs of individuals, recorded audio clips of the individuals, and an indication as to the gender of the individual. In a preferred embodiment, the training data set analyzed at step 220 is a large (e.g., 5,000 subjects or more) representative sample from a very large (e.g., 10,000 subjects or more) master training database containing data relating to test subjects. Most preferably, the data items contained in the master training database are carefully selected so as to include subjects of as many “categories” as possible. For example, such categories can include subjects having like skin tones, ages, ethnic backgrounds, body size, body type, etc. The training data set analyzed at step 220 is a subset taken from this master training database, and preferably the training data set is a cross-section of the master training database so that each category of the master training database is represented in the training data set and the representation of the categories in the training data set is consistent with the representation of categories in the master training database.

There are both similarities and differences between the appearance of a male face and a female face, and making the distinction based on simplistic (low dimensional) visual differences can be very difficult. For example, with respect to low dimensional visual data, the size and/or shape of facial features, the presence of facial hair, skin tones, and measured size characteristics (e.g., distance between the eyes of the individual) may or may not be able to help distinguish between a male and female subject. Similarly, low dimensional speech information such as data pertaining to voice pitch can be less than helpful in gender determination. Thus, in a presently preferred embodiment of the present invention, learning-based classification systems (e.g., SVMs) and/or known algorithms are used to extract high dimensional features that can be used to distinguish a male image from a female image or a male voice from a female voice. These high dimensional characteristics are mathematically based, i.e., they may be visually or audibly imperceptible. For example, a 20 pixel by 20 pixel image can be subjected to principle component analysis to extract 100 orthogonal coefficients, resulting in a 100-dimensional vector from which characteristics can be identified. Similarly, lexicographical ordering can be performed on a 20 pixel by 20 pixel image to generate a 400-dimensional vector which contains all possible variabilities of the captured image. By analyzing large data sets of images and voice samples, using known learning-based classification methods, features can be extracted which enable accurate gender determinations based on mathematical analysis.

At step 222, the extracted characteristics are correlated to the known gender of the individual and thus “trains” the system to recognize data having the same characteristics as being associated with the gender. At step 224, based upon this training, after the input of multiple data samples, a preliminary model based upon the training is created. When fully completed, this model will be used to compare raw data input to the system and to output a result based upon the comparison of the raw data to the model. At step 226, the preliminary model is tested against a smaller set (e.g., 1,000 subjects) of “refinement” data to refine the accuracy of the model. Thus, for example, at step 226, a known data set (preferably data that is not part of the initial training data set or master training database) is input to the preliminary model, and the results of the comparison are checked against the known gender to determine if the preliminary model yielded a correct result. One of the purposes of this step is to determine if there is a need to perform “bootstrapping.” Bootstrapping in the context of this invention involves the use of some or all of the refinement data that produced an incorrect result when used to test the preliminary model, as additional training data to refine the model.

Referring back to FIG. 2, at step 228 it is determined if any of the decisions made on the refinement data warrant bootstrapping. For each incorrect decision made by the preliminary model, the data that generated the incorrect result can be added to the training data set (step 230), subjected to the same learning-based classification steps to which the initial training data set had been subjected. Specifically, features are extracted from the refinement data that generated the error, the system is retrained to include the extracted features and they are correlated to the gender to which they apply to create a revised test model to be used for final testing (step 232). In a preferred embodiment, only a random sample of the error-generating refinement data is used for bootstrapping, to minimize the chance of improperly biasing the classifier.

At step 234, test data from a test data set is applied to the test model created in step 232. The test data set is an independent database comprising randomly selected subjects. Preferably, the test database is significantly larger than the refinement data set, for example, it can contain 5,000 or more subjects. The purpose of using this test data set is to evaluate the accuracy of the test model created in step 232. As with the training data and refinement data, the gender of each test subject in the test data set must be known so that accuracy can be checked. At step 236, a determination is made as to whether or not the accuracy of the test model is acceptable. If the accuracy of the model is acceptable, the process proceeds to step 238, where the model is finalized for use in decision making, and at step 240 the modeling process concludes.

However, if at step 236, it is determined that the accuracy of the test model is unacceptable, the process proceeds back to step 220, where a new training data set is selected from the master training database, and the training steps of the present invention are applied once again. Using this “trial and error” training system, eventually a model that is acceptable for use is derived and can be used for gender recognition.

At the end of the process (step 240), a final model exists which yields accurate results when raw data is input and applied against the model.

As noted above, performing the modeling process and then using the models on single mode data is well known. In accordance with the present invention, however, multiple modes are used, i.e., a first model is created respecting visual data and a second model is created respecting speech data. Then, a third model is generated which combines the outputs of the first two models to yield substantially more accurate results. The steps performed on the multi-mode data, referred to herein as “fusion modeling”, follows essentially the same process steps as those of FIG. 2. The primary difference is that during training, the results of the single mode comparisons are used to extract characteristics for both the speech and vision data, and then a model is produced that identifies the gender based upon the extracted characteristics. Just as in the case of the single mode analysis, during the training stage, since the gender of the training data is known, incorrect results based upon the combined comparison are bootstrapped, i.e., they are further analyzed, features extracted identifying the gender of the incorrect data, and this information is used to refine the multi-mode model. When the training process is complete, this third model will allow analysis of raw data that combines the benefits of the single mode analysis of the prior art.

To illustrate the concept of the present invention, a simple example using hypothetical and simplified characteristics of males and females is presented below. It is stressed that this example is given for purpose of explanation only, and that the characteristics used have been selected for their ease of conceptualization and not to suggest that they would actually be appropriate for use in actual practice of the invention.

In this example, it is desired to establish an automatic system (a classifier) for distinguishing between male and female humans. In accordance with the present invention, the process begins by taking training databases having representative sets of data pertaining to male and female subjects and analyzing the data sets to ascertain, i.e., extract, features which will help identify the gender of the test subjects. In this example there is a first training database containing digital “mugshot” photographs of the faces of the subjects, and a second training database containing speech samples of each of the subjects. The gender of the subjects is known so that the data can be used for training. These databases comprise the training sets, and the larger the number of subjects contained in the training sets, the better the results of the training will be.

To best extract the features for use in constructing the classification model, pre-processing steps can be performed on the data in the training databases to improve the ability to extract meaningful information pertaining to characteristics related to gender. For example, in the case of speech data, noise filtering can be performed to remove background noise that may exist in the sound recording. With respect to the visual data, lighting can be normalized and scaling can be performed so that the “environmental” aspects of the photographs are essentially similar across all samples.

Next, the training databases are subjected to an extraction process to extract features (cues) relevant to the gender classification. In this simplified example, the size (length and width) of the nose; the length (top to chin) of the head; and the pitch of the voice in the speech sample are the features that are extracted. As noted above, these features are used in this example due to their ease in conceptualization; in practice, example-based learning techniques are used to extract features that may not be perceived by human eyes or ears.

Once the features have been extracted, each feature is classified relative to the gender of the specimen that generated the feature, to create a model that will render a decision regarding gender based on a comparison of unknown (raw) data to the model Refinement data can be input to test each model and bootstrapping can be used to improve the models. Thus, upon completion of training in this example, a classifier (model) will have been created with respect to nose size, head size, and voice pitch.

For the purpose of this example, assume that analysis of the training set of data reveals the following:

1. If the ratio of nose length to nose width of a test subject is 1 or greater, the test subject is more likely a male, and that if the ratio of nose length to nose length of the test subject is less than 1, the test subject is more likely a female;

2. If the length of the head of the test subject is 7½ inches or greater, the test subject is more likely a male, and if the length of the test subject is less than 7½ inches, the test subject is more likely a female; and

3. If the speaking pitch of the test subject is 130 Hz. or less, the test subject is more likely a male, and if the speaking pitch of the test subject is higher than 130 Hz., the test subject is more likely a female.

Assume for simplicity of explanation that each of the sampled features (head size, nose length/width ratio, and speech pitch) can be characterized by a single “scaling” number such that samples found by the models to be generated by females are represented by negative scale number values (e.g., numbers −1 to −10, with a number further from zero indicating a higher likelihood that the sample was generated by a female) and samples found by the models to have been generated by males are represented by a positive scale number (e.g., numbers +1 to +10, with a number further from zero indicating a higher likelihood that the sample was generated by a male). Graphing each of the characteristics of the speech samples, a dividing line L represents the dividing line between male and female samples. All samples whose scale value falls to the right of the line dividing line L are classified as generated by males, and all those to the left of the dividing line L are classified as generated by females. The dividing line, referred to as the “decision boundary” is represented by zero, which identifies neither male or female.

With the system fully trained, it is now ready to be used to ascertain the gender of test subjects for which the gender is not previously known. The visual and speech data can be obtained for the test subjects in any known manner, for example, by directing test subjects to stand for a predetermined time period at a designated location in front of a camera that also records sound, and recite a simple phrase. Alternatively, data can be gathered without prompting but rather just by random photography and sound recording of an environment occupied by the test subjects.

In this example, four test subjects were used to illustrate the operation of and benefits gained from the present invention. The four test subjects are characterized as shown in Table 1:

TABLE 1

| | Actual | Nose | Head | Voice |
|---|---|---|---|---|
| Test Subject | Gender | Ratio/Scale | Length/Scale | Pitch/Scale |
| Subject 1 | Male | 1.2/+3 | 8.0″/+4 | 120 Hz./+2 |
| Subject 2 | Female | .7/−4 | 6.5″/−3 | 230 Hz./−5 |
| Subject 3 | Male | .8/−2 | 7.5″/+1 | 90 Hz./+5 |
| Subject 4 | Female | .95/−1 | 7.0″/−2 | 130 Hz./+1 |

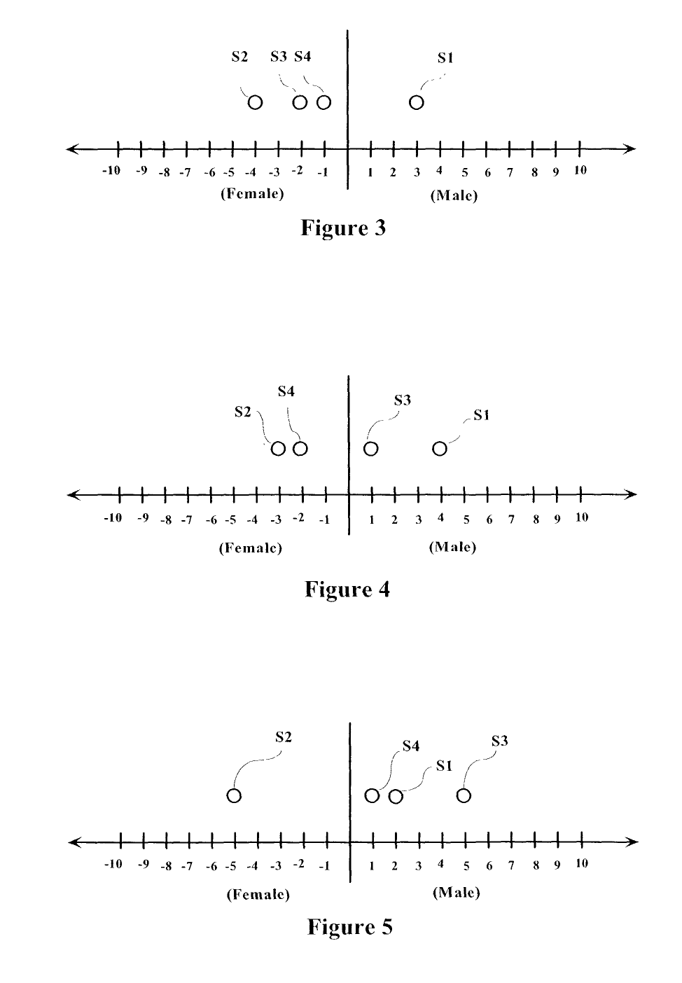

Simple number lines (FIGS. 3-5) illustrate the results that are obtained using the separate classifiers. As can be seen, the Nose Ratio classifier (FIG. 3) correctly identified Subject 1 as a male and Subjects 2 and 4 as females, but it incorrectly classified Subject 3 as a female as well. The Head Length classifier (FIG. 4) correctly identified Subject s 1 and 3 as males and Subjects 2 and 4 as females. Finally, the Voice Pitch classifier (FIG. 5) correctly identified Subject 2 as a female and Subjects 1 and 3 as males, but it also incorrectly identified Subject 4 as a male.

However, if the results of the three classifiers are combined in accordance with the present invention, the correct results are obtained each time. In the simplest form, taking the results of each of the three classifiers and using a “simple majority rules” approach, for Subject 1 there are 3 “votes” for male; Subject 2 there are 3 “votes” for female; for Subject 3 there are 2 votes for male and 1 vote for female (allowing a correct conclusion of “male” for Subject 3); and for Subject 4 there are 2 votes for female and 1 vote for male (allowing a correct conclusion of “female” for Subject 4).

As will be apparent to one of ordinary skill in the art, if the weight of the scaled values is taken into consideration, there is an even greater ability to correctly ascertain the gender of test subjects. For example, Subject 3 has a Voice Pitch scale value of 15, indicating a strong likelihood that the voice sample came from a male test subject. This value can be given greater weight when assessing the results from the multiple classifiers. Likewise, better results are obtained by increasing the number of classifiers used.

As noted above, it is stressed that the example given is greatly simplified. In reality, pattern recognition tasks based upon visual analysis of human face is are extremely complex and in may not be possible to articulate the features used to identify “maleness” or “femaleness”. For this reason, example-based learning schemes such as SVMs are utilized to allow identification of characteristics “visible” to the processor by very likely imperceptible to a human analyzing the same data. Further, better results will be obtained if more than three features are extracted.

As noted above, in a preferred embodiment, the multi-modal gender classification is conducted using SVMs. The choice of an SVM as a classifier can be justified by the following facts. The first property that distinguishes SVMs from previous nonparametric techniques, like nearest-neighbors or neural networks, is that SVMs minimize the structural risk, that is, the probability of misclassifying previously unseen data point drawn randomly from a fixed but unknown probability distribution instead of minimizing the empirical risk that is the misclassification on training data. Secondly, SVMs condense all the information contained in the training set relevant to classification in the support vectors. This reduces the size of the training set, identifying the most important points, and makes it possible to efficiently perform classification in high dimensional spaces.

To circumvent the shortcomings of individual modalities the inventors have developed multi-modal learning (MML) to fuse the audio and visual cues (features). Gender classification is first performed using visual and audio cues using SVMs. During classification an SVM classifier establishes the optimal hyper-plane separating the two classes of data. An approximate of this distance measure is calculated from the output of the individual classifier for both the vision and the speech based gender classifier. The distance measure mentioned along with the decision is used to train a final classifier. The individual decisions regarding gender obtained from speech and vision based SVM classifiers is fused to obtain the final decision. Information from the individual classifiers is used to improve on the final decision. The novel fusion strategy involving decision level fusion was found to perform robustly in experiments.

In MML the decision of the base classifier (developed using the individual modalities) is used as an input to a final classifier to obtain a final decision. The proposed approach can make use of unimodal data, which are relatively easy to collect and are already publicly available for modalities like vision and speech. Also the architecture of this type of system benefits from existing and relatively mature unimodal classification techniques.

### Experimentation Results

The following gender classification experiment was conducted to demonstrate the feasability of the present invention. The overall objectives of the experimental investigation were: 1) to perform gender classification fusing multimodal information, and 2) to test the performance on large database. Gender classification was first carried out independently using visual and speech cues respectively, consistent with the operations illustrated in FIG. 1. Two distinct SVMs were trained using thumbnail face images and Cepstral features extracted from speech samples as input. As shown in FIG. 1, the Vision and Speech blocks represent the gender classification procedure using the individual modality. The individual experiments involved the following: 1) data collection, 2) feature extraction, 3) training, 4) classification and performance evaluation. A decision regarding gender was obtained using each modality. The output of the individual classifiers was then fused to obtain a final decision.

Design of Vision-Based Gender Classifier

The design of the vision-based classifier was accomplished in four main steps: 1) data collection, 2) preprocessing and feature extraction, 3) system training and 4) performance evaluation. The first step of the experiment was to collect enough data for training the classifier.

Data Collection

The data required for vision experiments consisted of “thumbnail” face images. Several different databases containing large number of face images were collected. Frontal un-occluded face images were selected from seven different face databases (ORL, Oulu, Purdue, Sterling, Sussex, Yale and Nottingham face databases) and a new compound training database was created. The total number of such frontal face images was approximately 600 and an additional 600 samples that were mirror images of the original set were added making a total of 1200 images for training. A different set of 230 face images was collected from a different source to form the test images (refinement data). Hence the refinement data set comprised images that were different from the training set. Since the training images belonged to seven different databases, there was significant variation within the compound training database in terms of size of images, their resolution, illumination, and lighting conditions. The next step of the experiment was to perform preprocessing and feature extraction on the collected data.

Preprocessing and Feature Extraction

A known face detector was used to extract the 20×20 thumbnail face images from the large face database. The face detector used in this research was the Neural Network based face detector developed by Yeasin et al., based on the techniques adopted from Rowley et al., and Sung et al. The faces detected were extracted and rescaled if necessary to a 20×20 pixel size. The intensity values of these faces are stored as a 400-dimension vector. Out of the 1200 training images, faces from 1056 images were extracted. Thus, a 1056×400 dimensional intensity matrix was created as input to train the SVM. Similarly, 216 faces out of 230 refinement data images were extracted to form a 216×400 dimensional matrix.

Training

The process of using data to determine the classifier is referred to as training the classifier. From the knowledge of SVM theory it is known how to determine the value of Lagrange multipliers and select appropriate kernels. The training and classification was carried out in Matlab (ISIS SVM toolbox) using the quadratic programming package provided therein. The SVMs are used to learn the decision boundary from training data to thus “learn” the model that allows the gender classification.

The first step was choosing the kernel function that would map the input to a higher dimensional space. Past work on vision-based gender classification using SVMs has shown good recognition with Polynomial and Gaussian Radial Basis functions. Hence these functions were used for the kernel function. Good convergence was found for the Polynomial kernel. Another parameter given as an input to the training algorithm along with the input data and the kernel function is the bound on Lagrange multiplier. In the absence of a reliable and efficient method to determine the value of C, which is the upper bound on the Lagrange multiplier, the known approach of trial and error can be used. Training is carried out for all values of c ranging from zero to infinity. In general, as C→∞ the solution converges towards the solution obtained by the optimal separating hyperplane. In the limited as C→0 the solution converges to one that minimizes the error associated with the slack variable. There is no emphasis on maximizing the margin but purely on minimizing the misclassification error. The value of bound C was varied to achieve around 10%-15% support vectors. Once the SVM was trained, the next step was testing it for classification.

Performance Evaluation

In this step of pattern recognition system the trained classifier assigns the input pattern to one of the pattern classes, male or female gender in this case, based on the measured features. The test set of 216 faces obtained after feature extraction was used to test the performance of the classifier. Here the goal was to tune the classifier at the appropriate combination of the kernel function and bound C to achieve minimum error of classification. The percentage of misclassified test samples is taken as a measure of error rate. The performance of the classifier was evaluated and further steps such as bootstrapping were carried out to further reduce the error of classification with better generalization. Out of the tested images the ones that were misclassified were fed back to the training. Sixty-nine (69) images were misclassified which were added to the training set. The SVM was trained again with the new training set of 1125 images and tested for classification with the remaining 147 images.

Design of Speech-Based Gender Classifier

To the knowledge of the inventors herein, an SVM classifier has not in the past been investigated for speech-based gender classification. Unlike vision, the dimensionality of feature vectors in speech-based classification is small, and thus it was sufficient to use any available modest size database. The design of the speech-based classifier was accomplished in four main stages: 1) Data Collection, 2) feature extraction, 3) system training and 4) performance evaluation. The first step of the experiment was to collect enough data for training the classifier.

Data Collection

The only major restriction on the selection for the speech data was the balance of male and female samples in the database. The ISOLET Speech Corpus was found to meet this criterion and was chosen for the experiment. ISOLET is a database of letters of the English alphabet spoken in isolation. The database consists of 7800 spoken letters, two productions of each letter by 150 speakers. The database was very well balanced with 75 male and 75 female speakers. 300 utterances were chosen as training samples and separate 147 utterances as testing samples. The test set size was chosen to be 147 in order to make it equal to the number of testing samples in case of vision. This had to be done in order to facilitate implementation of the fusion scheme described later. The samples were chosen so that both the training and testing sets had totally mixed utterances. The training set had balanced male-female combination. Once the data was collected the next step was to extract feature parameters from these utterances.

Feature Extraction

Speech exhibits significant variation from instance to instance for the same speaker and text. The amount of speech generated by short utterances is quite large. Whereas these large amounts of information is needed to characterize the speech waveform, the essential characteristic of the speech process changes relatively slowly, permitting a representation requiring significantly less data. Thus feature extraction for speech aims at reducing data while still retaining unique information for classification. This is accomplished by windowing the speech signal. Speech information is primarily conveyed by the short time spectrum, the spectral information contained in about 20 ms time period. Previous research in gender classification using speech has shown that gender information in speech is time invariant, phoneme invariant, and speaker independent for a given gender. Also research has proved that using parametric representations such as LPC or reflection coefficient as a feature for speech is practically plausible. Thus, Cepstral feature was used for gender recognition.

The algorithm described by Gish and Schmidt (Gish and Schmidt, “Text-independent speaker identification,” IEEE Signal Processing Magazine, pp. 18-32 (1994)) was used to extract Cepstral features. The input speech waveform was divided into frames of duration 16 ms with an overlap of 10 ms. Each frame was windowed to reduce distortion and zero padded to a power of two. The speech signal was moved to the frequency domain via a fast Fourier transform (FFT) in a known manner. The cepstrum was computed by taking the FFT inverse of the log magnitude of the FFT:

Cepstrum (frame)=FFT⁻¹ (log|FFT (frame)|).

The inverse Fourier transform and Fourier transform are identical to within a multiplicative constant since log |FFT| is real and symmetric; hence the cepstrum can be considered the spectrum of the log spectrum. The Mel-warped Cepstra were obtained by inserting the intermediate step of transforming the frequency scale to place less emphasis on high frequencies before taking the inverse FFT. The first 12 coefficients of the Cepstrum were retained and given as input for training.

Training

The dimension of the input feature matrix was 300×12. The two most commonly used kernel functions; Polynomial and Radial Basis Function were tried. In case of speech good convergence was obtained using the Radial Basis Function mapping. The Radial Basis Function with σ=3 resulted in support vectors that were about 5%-25% of the training data. The time required for training was much less compared to vision due to the smaller dimension of the input vector. The number of support vectors obtained at the end of training was very sensitive to the variation in the value of C. The value of C was varied from zero to infinity. The value of Lagrange multipliers was noted at various values of C that achieved around 10%-15% support vector. Further testing was carried out for all these cases.

Performance Evaluation

The test set of utterances was given to the classifier to evaluate its performance. The classification was carried out exactly the same as was done for the vision method and the SVM was fine-tuned to give the lowest possible classification error. Similar to the vision-based method bootstrapping was performed to obtain better generalization and reduce the error rate. Any test samples that were misclassified were added to the training set and the test set was replaced by new samples to make the total size still the same, i.e., 147 samples. This was done so that an equal number of vision and speech samples would be available for the fusion process.

Fusion Mechanism

It is noted that the modalities (vision and speech) under consideration are orthogonal. Hence, semantic level fusion was favored. The individual decisions regarding gender obtained from the speech and vision based SVM classifiers were fused to obtain the final decision. During classification, the SVM classifier establishes the optimal hyper-plane separating the two classes of data. Each data point is placed on either side of the hyper-plane at a certain distance given by:

$$d ( w , b ; x ) = \frac{\vert w \cdot x + b \vert}{‖ w ‖} \qquad ( 1 )$$

An approximate estimate of this distance measure was calculated from the output of the individual classifier for the test samples for both the vision and the speech based gender classifier. A decision (target class, +1 or −1) was assigned to each pair of distance measures belonging to a particular gender. This distance measure mentioned above served as the input feature vector to train a third SVM along with the decision vector. The final stage of the SVM classifier established a hyper-plane separating this simple 2-dimensional data. This SVM classifier works with a simple linear kernel function, as the dimensionality of the data is low.

Results for Vision-Based Gender Classification

The experiments began by first performing gender classification using face images. Based on the available data, the SVM was trained using a total of 1056 face images of size 20×20 pixels consisting of 486 females and 580 males. The kernel function used to carry out the mapping was a third degree polynomial function. The parameter C (upper bound on Lagrange multipliers) was varied from zero to infinity. For certain values of c the hyperplane drawn was such that the number of support vectors obtained was a small subset of the training data as expected. There were quite a bit of variations in the number of support vectors but in general the range varied from 5% to 45% of the training data. The SVM-based classifier was tested for classification using the test set of 216 images drawn from outside the training samples obtained from a different source. The male-female saple for the test set was 123-93, respectively. The combination of kernel function and value of C that gave the minimum misclassifications was chosen and the number of support vectors (SVs) were noted.

The minimum error rate obtained was 31.9%, which was quite high. Poor generalization ability was identified as a problem in this case. The 69 samples that were misclassified were noted and were added to the training set. The commonly used technique called bootstrapping was used for a better generalization and to improve the accuracy of the classifier. The classifier was thus trained with the new larger data set of 1125 images. The reduced 147 test (refinement data) samples were then tested and the error of classification was noted. The results for both cases before and after bootstrapping were as shown in Table 2.

Bootstrapping reduced the error rate dramatically from 31.9% to 9.52%. This was a considerable reduction in error. The number of support vectors in both cases was around 30% of the training data and is shown in Table 2. A further step of bootstrapping could have resulted in better accuracy but this implied reduction in the available testing examples. Analyzing results based on such small data then would have been meaningless. Accepting the accuracy achieved after the single bootstrapping step was justified considering the diversity within the training samples, originating from seven different databases. Moreover the refinement data was completely different coming from an altogether different source.

TABLE 2

| | Size of Data | | Kernel | Support Vectors | Classification |
|---|---|---|---|---|---|
| Modality | Training | Testing | Function | (% Training data) | Error |
| Vision | 1056 | 216 | Cubic | 28.9% | 31.9% |
| | | | Polynomial | | |
| Vision | 1125 | 147 | Cubic | 32.9% | 9.52% |
| (Bootstrap) | | | Polynomial | | |

An analysis of the error obtained before bootstrapping revealed that more number of female images were misclassified than male. Out of the 69 images misclassified 51 were female images and the rest 18 male. Such a high error rate in classifying female faces has been observed in the past by Moghaddam and Yang. Their work with more than one classifier resulted in higher error rates in classifying females. This could be due to the less prominent and distinct facial features in female faces.

Results for Speech-Based Gender Classification

The experiments using speech had more flexibility than vision experiments, as there was enough data available. During feature extraction 12 Cepstral coefficients were extracted per utterance. Hence the dimensionality of input vector was quite low. A total of 300 samples were chosen for training. The number of test samples was 147, which was equal to the test data size used in vision experiments. The training and refinement data sets of the third SVM for fusion was created out of the 147 samples of the individual test sets. This was done to facilitate comparison of results for the individual techniques to the multimodal case. The number of male-female samples in the test data was kept the same. The dimension of the input training matrix were 300×12 and the size of the test matrix was 147×12. In case of speech, training converged for the radial basis function kernel of width 3. Training was carried out for a wide range of values of the parameter C, varying from zero to infinity. The effect of variation of C was significant

When tested for classification with the 147 test samples, the error rate was 16.8%. In this case too, bootstrapping was performed maintaining the original size of database. Bootstrapping in case of speech resulted a reduction of error rate from 16.8% to 11%. The results the speech experiments before and after bootstrapping are shown in Table 3.

TABLE 3

| | Size of Data | | Kernel | Support Vectors | Classification |
|---|---|---|---|---|---|
| Modality | Training | Testing | Function | (% Training data) | Error |
| Speech | 300 | 147 | RBF | 15% | 16.32% |
| | | | (σ = 3) | | |
| Speech | 300 | 147 | RBF | 17.7% | 11.5% |
| (Bootstrap) | | | (σ = 3) | | |

The reduction in error rate was not as significant as in the case of vision. One possible explanation for the better performance of speech prior to bootstrapping could be the lesser variation in speech data. In the case of speech, both the training and testing data were obtained from the same database, although the subjects and utterances were not common to both. Hence, providing the error samples during bootstrapping did not cause a considerable difference in the already good performance of the classifier. The time required for optimization case of speech was about 10-15 minutes owing to the smaller dimension of input matrix. The number of support vectors obtained during training for speech before and after bootstrapping was around 16% of the training data. As in the case of vision the rate of misclassifying female samples was found to be almost double the male misclassifications.

Results for Fusion of Vision and Speech

The approximate distance measure for each point on either side of the hyperplane was computed during classification. This distance measure was obtained separately for each modality and a decision was assigned to the pair of distance measures of the 147 test samples. The 147-sized test (refinement) data of individual experiments was divided into two sets, 47 for training and 100 as a test set to the fusion SVM classifier. The distribution of error samples and male-female distribution were kept in mind whie creating the training and test data for the final stage classifier. The samples taken from the vision and speech test set reflected the error rate obtained for the individual vision and speech experiments, respectively. Moreover, the percentage of male-female samples in the 147 test data was maintained when the data was split to 47 and 100 samples. The split of 47-100 was also done for a reason. It was necessary to have a larger number of examples for testing in order to have meaningful results established based on a large sized database. Moreover, the fusion SVM training data was a simple two-dimensional matrix, and thus training could be done with a small (47 samples) amount of data.

Once the training and test sets were created the SVM was trained. Due to the small size of the data, mapping with a linear kernel function worked well in this case. Owing to this simplicity of the fusion SVM, the time required for training was only 1-2 minutes. The SVM was tested for classification and the results obtained are shown in Table 4. The number of support vectors obtained was 15% of the training data. It is evident from Table 3, the number of misclassifications were reduced substantially from 9.52% in case of vision and 11.5% in speech to just 5% for the multi-modal case. This was also obtained after bootstrapping the data. In this case the error samples were fed to the training set and some samples from the training set were replaced in the test data. Prior to bootstrapping the error rate was about 8%.

TABLE 4

| | Size of Data | | Kernel | Support Vectors | Classification |
|---|---|---|---|---|---|
| Modality | Training | Testing | Function | (% Training data) | Error |
| Vision + | 47 | 100 | Linear | 15% | 5% |
| Speech | | | | | |

The results of fusion validated the primary goal of this work. Multimodal fusion worked extremely well resulting in a significant reduction in classification error. This fusion approach was not only simple from the implementation point of view but also had a strong theoretical basis. While performing fusion of modalities at the decision level, it was necessary to take into account the decisions obtained from individual classifier. In other words, the feature provided as input to the SVM should count for the inherent accuracy of the individual classifier. In this case, calculating the distance measure accounted for the hyperplane drawn in each case and represented the confidence in the data. Thus, the decision of the final classifier was based on a judicious decision of the individual classification and reinforcement of the learning.

Results for Multi-Modal Data

To further exemplify the efficacy of the proposed method the system was tested on a standard commercially available multi-modal database. The M2VTS (Multi-Modal Verification for Teleservices and Security applications) database consisting of 37 people was chosen for the experiment. The results obtained for the 37 samples tested are as shown in Table 5. Testing the M2VTS database on vision achieved reasonably good accuracy. For speech the error was very high. The reason for this was that the speech data in the multi-modal database was a database consisting of utterances of French words. Hence, the utterances were completely different from what the data the classifier was trained on. In this case too, the results obtained after fusion of vision and speech show a considerable reduction in classification error.

TABLE 5

| | Size of Data | | Kernel | Support Vectors | Classification |
|---|---|---|---|---|---|
| Modality | Training | Testing | Function | (% Training data) | Error |
| Vision | 1125 | 37 | Cubic | 32.9% | 16.21% |
| | | | Poly. | | |
| Speech | 300 | 37 | RBF | 17.7% | 40.54% |
| | | | (σ = 3) | | |
| Vision + | 47 | 37 | Linear | 15% | 13.52% |
| Speech | | | | | |

Discussion

Gender classification is a binary classification problem. The visual and audio cue have been fused to obtain a better classification accuracy and robustness when tested on a large data set. The decisions obtained from individual SVM-based gender classifiers were used as input to train a final classifier to decide the gender of the person. As the training is always done off-line, this limitation does not pose any threat to potential real-time application.

SVMs are powerful pattern classifiers as the algorithm minimizes structural risk as opposed to empirical risk and are relatively simple to implement and can be controlled by varying essentially only two parameters, the mapping function and the bound C. A data set of a size three times that of the dimension of the feature vector was sufficient to train the SVMs to achieve a better accuracy. The problem of generalization and classification accuracy is significantly improved using bootstrapping. The mapping was found to be domain specific as it was observed that the good performance of classification for vision and speech was found for different kernel. Fusion of vision and speech for gender classification resulted in an improved overall performance when tested on large and diverse databases.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-2 support combinations of means for performing the specified functions, combinations of steps for performing the specified functions, and program instruction means for performing the specified functions.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of a machine running the program. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

Although the present invention has been described with respect to a specific preferred embodiment thereof, various changes and modifications may be suggested to one skilled in the art. For example, while speech and vision are given as the examples of multi-mode gender classification, it is understood that other modes, e.g., handwriting analysis, movement, general physical characteristics, and other modes may be used in connection with the multi-modal gender classification of the present invention. Further, while SVMs are given as the learning-based classification method of choice, it is understood that other learning-based classification methods can be incorporated in the invention and are considered covered by the claims. It is intended that the present invention encompass all such changes and modifications as fall within the scope of the appended claims.

We claim:

1. A computer software system for multi-modal human gender classification, comprising:
a first-mode classifier classifying first-mode data pertaining to male and female subjects according to gender and rendering a first-mode gender-decision for each male and female subject;
a second-mode classifier classifying second-mode data pertaining to male and female subjects according to gender and rendering a second-mode gender-decision for each male and female subject; and
a fusion classifier integrating the individual gender decisions obtained from said first-mode classifier and said second-mode classifier and outputting a joint gender decision for each of said male and female subjects.

2. A computer software system as set forth in claim 1, wherein said first mode classifier is a vision-based classifier; and
wherein said second mode classifier is a speech-based classifier.

3. A computer software system as set forth in claim 2, wherein said speech-based classifier comprises a support vector machine.

4. A computer software system as set forth in claim 2, wherein said first-mode classifier, second-mode classifier, and fusion classifier each comprise a support vector machine.

5. A computer software system for multi-modal human gender classification, comprising:
means for storing a database comprising a plurality of male and female facial images to be classified according to gender;
means for classifying the male and female facial images according to gender;
means for storing a database comprising a plurality of male and female utterances to be classified according to gender;
means for classifying the male and female utterances according to gender;
means for integrating the individual gender decisions obtained from the vision and speech based classification means to obtain a joint gender decision, said multi-modal gender classification having a higher performance measurement than the vision or speech based means individually.

6. A multi-modal method for human gender classification, comprising the following steps, executed by a computer:
generating a database comprising a plurality of male and female facial images to be classified;
extracting a thumbnail face image from said database;
training a support vector machine classifier to differentiate between a male and a female facial image, comprising determining an appropriate polynomial kernel and the bounds on Lagrange multiplier;
generating a database comprising a plurality of male and female utterances to be classified;
extracting a Cepstrum feature from said database;
training a support vector machine classifier to differentiate between a male and a female utterance, comprising determining an appropriate Radial Basis Function and the bounds on Lagrange multiplier;
integrating the individual gender decisions obtained from the speech and vision based support vector machine classifiers, using a semantic fusion method, to obtain a joint gender decision, said multi-modal gender classification having a higher performance measurement that the speech or vision based modules individually.

7. The method of claim 6 wherein the performance of the support vector machine classifier is further augmented, comprising the steps of:
testing the support vector machine classifier by employing a plurality of refinement male and female facial images to be classified by the support vector machine classifier according to gender; and
using the refinement facial images for which gender was improperly detected to augment and reinforce the support vector machine learning process.

8. The method of claim 7 wherein the performance of the support vector machine classifier is further augmented, comprising the steps of:
testing the support vector machine classifier by employing a plurality of refinement male and female utterances to be classified by the support vector machine classifier according to gender; and
using the refinement utterances for which gender was improperly detected to augment and reinforce the support vector machine learning process.
